(19) United States
(12) Patent Application Publication
(10) Pub. No.: US 2026/0012719 A1
(43) Pub. Date: Jan. 8, 2026

(54) SMART GLASSES AND MANUFACTURING METHOD THEREOF

(71) Applicant: HTC Corporation, Taoyuan City (TW)

(72) Inventors: Jhih-Ming Jhang, Taoyuan City (TW); Ping-Hung Tsai, Taoyuan City (TW); Chun-Lung Chu, Taoyuan City (TW)

(73) Assignee: HTC Corporation, Taoyuan City (TW)

(21) Appl. No.: 19/078,302

(22) Filed: Mar. 13, 2025

Related U.S. Application Data
(60) Provisional application No. 63/668,316, filed on Jul. 8, 2024.

(51) Int. Cl. H04R 1/08; H04N 23/57; H04R 1/02; H04R 1/04; H04R 1/10; H04R 1/32

(52) U.S. Cl. CPC H04R 1/086; H04N 23/57; H04R 1/028; H04R 1/04; H04R 1/1008; H04R 1/326

(57) ABSTRACT

Provided are smart glasses and a manufacturing method thereof. The smart glasses include a frame, a motherboard and a directional microphone module. The frame includes a body and two temples. The body has a first opening. The motherboard is disposed in one of the temples. The directional microphone module is embedded in the body and closely combined with the body. The directional microphone module is electrically connected to the motherboard and has a first sound receiving hole. The first sound receiving hole communicates with the first opening.

### CROSS-REFERENCE TO RELATED APPLICATION

This application claims the priority benefit of U.S. provisional application Ser. No. 63/668,316, filed on Jul. 8, 2024. The entirety of the above-mentioned patent application is hereby incorporated by reference herein and made a part of this specification.

### BACKGROUND

### Technical Field

The disclosure relates to a device and a manufacturing method thereof, and in particular relates to smart glasses and a manufacturing method thereof.

### Related Art

With the advancement of technology, people's daily lives are more closely combined with technology. Not only smartphones, but even glasses may be combined with technology to provide smart functions. In order to further expand the functions of smart glasses, a microphone may be disposed on the smart glasses. However, how to maintain an overall volume and weight of the glasses to be lightweight while adding the microphone is also a problem that needs to be overcome.

### SUMMARY

The disclosure provides smart glasses and a manufacturing method thereof, which can improve a problem of significant increase in an overall volume and weight due to an addition of a microphone.

The smart glasses of the disclosure include a frame, a motherboard, and a directional microphone module. The frame includes a body and two temples. The body has a first opening. The motherboard is disposed in one of the temples. The directional microphone module is embedded in the body and closely combined with the body. The directional microphone module is electrically connected to the motherboard and has a first sound receiving hole. The first sound receiving hole communicates with the first opening.

The method of manufacturing smart glasses of the disclosure includes the following steps. A directional microphone module is assembled on a first member of a body of a frame. The directional microphone module has a first sound receiving hole. An insert molding process is performed to form a second member of the body. The second member is closely combined with the directional microphone module and the first member that have been assembled. The body has a first opening. The first sound receiving hole communicates with the first opening. A motherboard is disposed in one of two temples of the frame. The directional microphone module is electrically connected to the motherboard.

Based on the above, in the smart glasses and the manufacturing method thereof according to the disclosure, the smart glasses have a small volume and a light weight, having both lightweight and convenience.

### BRIEF DESCRIPTION OF THE DRAWINGS

FIG. 1 is a schematic view of smart glasses according to an embodiment of the invention.

FIG. 2 is an exploded schematic view of the smart glasses in FIG. 1.

FIG. 3 is an exploded schematic view of FIG. 2 from another viewing angle.

FIG. 4 is a schematic view of a first step of a method of manufacturing the smart glasses in FIG. 1.

FIG. 5 is an exploded schematic view of the smart glasses in FIG. 4.

FIG. 6 is an exploded schematic view of the smart glasses in FIG. 4 from another viewing angle.

### DESCRIPTION OF THE EMBODIMENTS

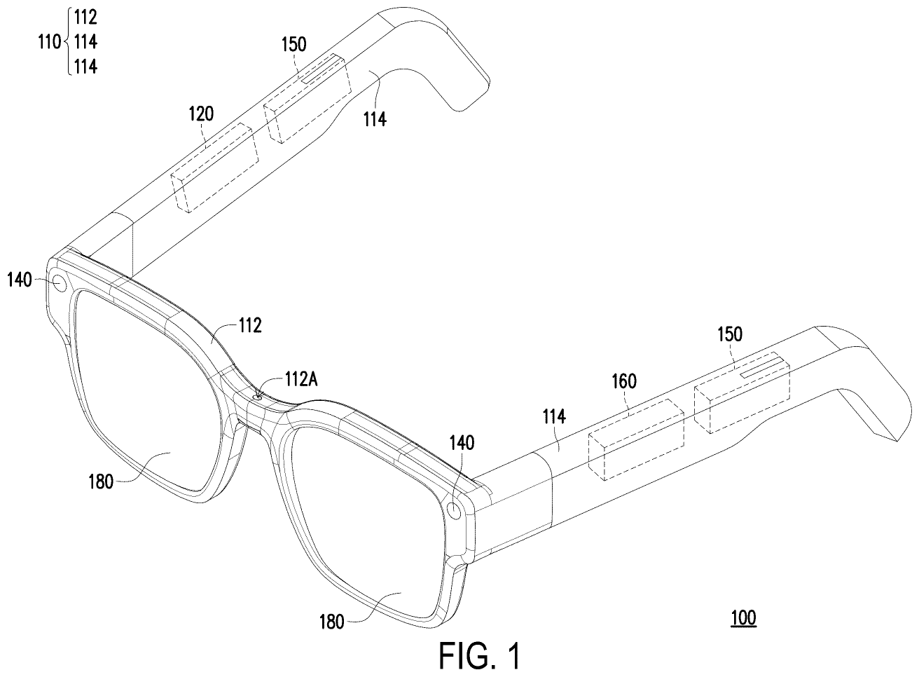

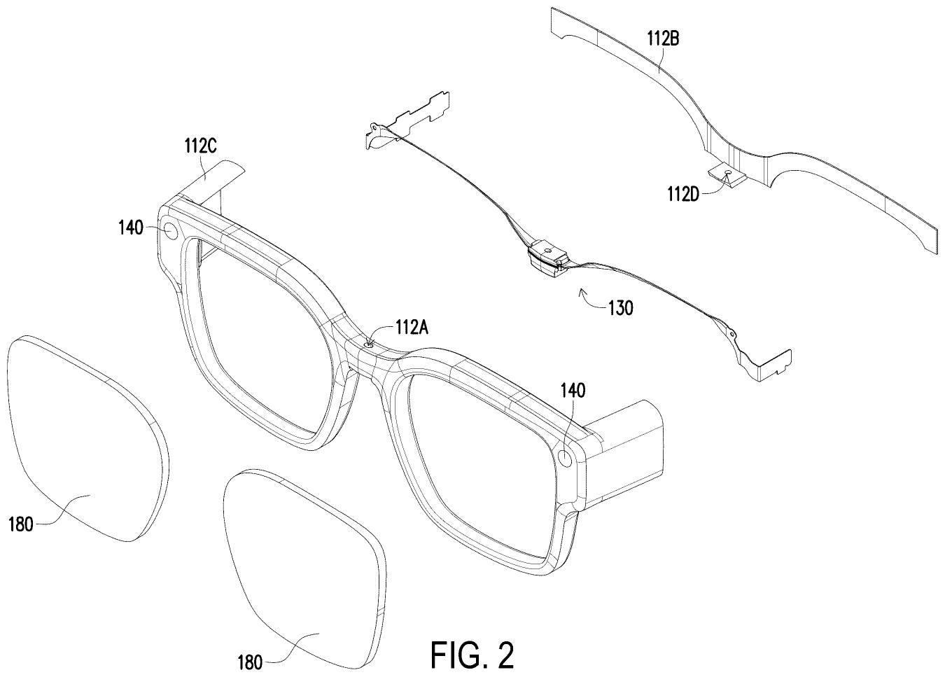

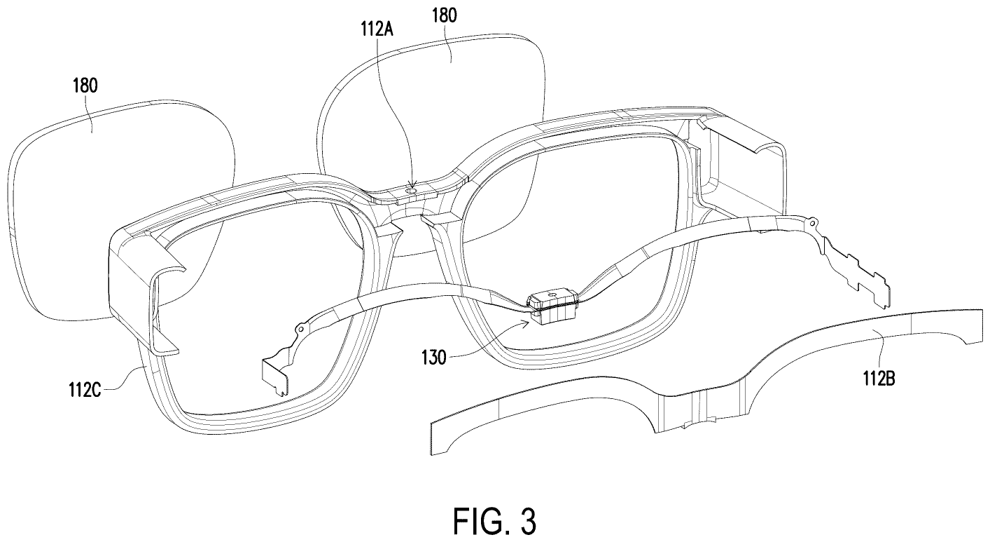

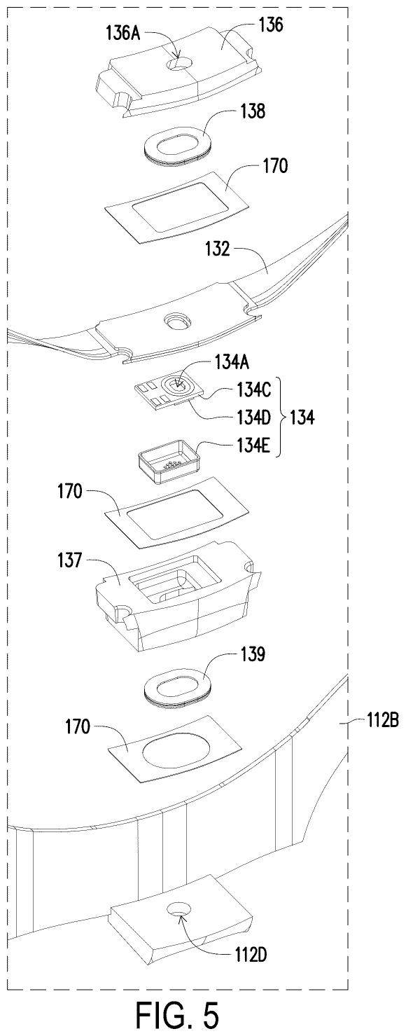

FIG. 1 is a schematic view of smart glasses according to an embodiment of the invention. FIG. 2 is an exploded schematic view of the smart glasses in FIG. 1. FIG. 3 is an exploded schematic view of FIG. 2 from another viewing angle. Referring to FIG. 1 to FIG. 3, smart glasses 100 of the embodiment include a frame 110, a motherboard 120, and a directional microphone module 130. The frame 110 includes a body 112 and two temples 114. The body 112 has a first opening 112A. The motherboard 120 is disposed in one of the temples 114. The directional microphone module 130 is embedded in the body 112 and closely combined with the body 112. The directional microphone module 130 is electrically connected to the motherboard 120 and has a first sound receiving hole 134A (marked in FIG. 5). The first sound receiving hole 134A communicates with the first opening 112A.

The directional microphone module 130 being closely combined with the body 112 means that there is no apparently visible gap between the two, and the structure must be damaged to separate the two. This is because, before the directional microphone module 130 and the body 112 are combined, the body 112 is not composed of one or more independent assemblies, but rather a material of the body 112 is fixed into a final shape in a final combining step.

In the smart glasses 100 of the embodiment, since the directional microphone module 130 is closely combined with the body 112, the directional microphone module 130 may be ensured to obtain a good waterproof effect. Moreover, an overall volume and weight of the smart glasses 100 are reduced as much as possible to allow the user to have better flexibility and convenience when operating the smart glasses 100.

In the embodiment, the body 112 includes, for example, a first member 112B and a second member 112C. The directional microphone module 130 is fixed on the first member 112B. The first member 112B and the second member 112C are closely combined. The second member 112C has the first opening 112A. Actually, in a finished product of the smart glasses 100, the first member 112B and the second member 112C may not be detached from each other in a non-damaging manner. Similarly, the directional microphone module 130 may not be detached from the first member 112B and the second member 112C in a non-damaging manner.

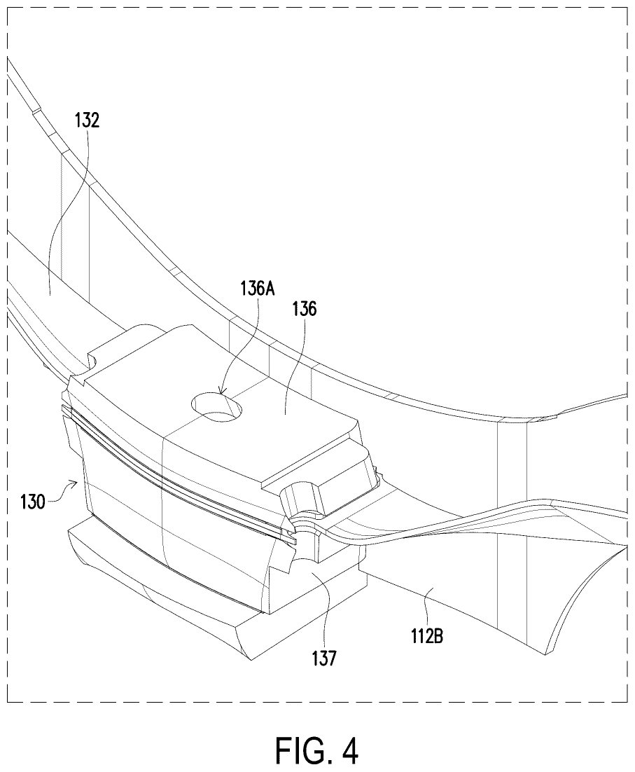

FIG. 4 is a schematic view of a first step of a method of manufacturing the smart glasses in FIG. 1. Referring to FIG. 2 and FIG. 4, the method of manufacturing the smart glasses 100 of the embodiment includes the following steps. First, the directional microphone module 130 is assembled on the first member 112B of the body 112 of the frame 110. In this manner, it may be ensured that the directional microphone module 130 is located at a desired location in the finished product of the smart glasses 100. Next, an insert molding process is performed to form the second member 112C of the body 112. For example, the directional microphone module 130 and the first member 112B that have been assembled are placed together and fixed in a mold (not shown), and then a package material is filled in a cavity of the mold. The package material covers most part of the directional microphone module 130. The step of filling the package material may be performing the insert molding process, such as low pressure molding (LPM). The package material may be epoxy resin or other materials. Then, the package material is cured to form the second member 112C of the body 112. During the insert molding process, a material of the first member 112B might partially enter a molten state and fuse with the second member 112C and become inseparable after re-curing. In other words, the first member 112B is closely combined with the second member 112C.

Therefore, after the second member 112C of the body 112 is formed, the assembly of the directional microphone module 130 and the body 112 is completed. Moreover, this manufacturing method allows no assembly gap to exist between the first member 112B and the second member 112C of the body 112, and no assembly gap exists between the directional microphone module 130 and the body 112. In this way, assembly procedures may be decreased and assembly errors may be avoided. The overall volume of the smart glasses 100 may also be shrunk. The possibility of sound leakage from the directional microphone module 130 may be reduced, thereby enhancing the sound receiving effect.

In the embodiment, the first member 112B may be formed through an injection molding process, but the disclosure is not limited thereto. In the embodiment, the first opening 112A is formed in the second member 112C. That is, during the insert molding process, a location where the first opening 112A is to be formed needs be reserved to prevent the package material from filling that area in order to form the first opening 112A that communicates with the first sound receiving hole 134A. For example, an insert pin is placed at the location where the first opening 112A is to be formed, so that after the insert molding process is completed, and the insert pin is removed, the first opening 112A may be formed.

In the embodiment, the first member 112B has, for example, a second opening 112D. The directional microphone module 130 further has, for example, a second sound receiving hole 134B. The second sound receiving hole 134B communicates with the second opening 112D. That is, when the user wears the smart glasses 100, the directional microphone module 130 of the embodiment may not only perform directional sound receiving toward a lower direction, but may also perform directional sound receiving toward an upper direction. Similarly, an insert pin is placed at a location where the second opening 112D is to be formed, so that after the injection molding process is completed, and the insert pin is removed, the second opening 112D may be formed.

Please refer to FIG. 1 again. In the embodiment, the smart glasses 100 may further include two cameras 140, which are disposed on both sides of the body 112 and electrically connected to the motherboard 120. The cameras 140 may capture images of a surrounding environment, and may also utilize the captured images to perform positioning. The smart glasses 100 of the embodiment may further include two speakers 150, which are respectively disposed in the two temples 114 and electrically connected to the motherboard 120 to allow the smart glasses 100 to also have a sound playback function. Additionally, in the embodiment, the smart glasses 100 may further include a battery 160, which is, for example, respectively disposed in the two temples 114 with the motherboard 120 to allow the smart glasses 100 to operate without an external power source, thereby enhancing the convenience during usage.

Moreover, in the smart glasses 100 of the embodiment, the two temples 114 of the frame 110 are, for example, connected to the body 112 in a bendable manner, but the disclosure is not limited thereto. The smart glasses 100 of the embodiment may further include two cameras 180. The lens 180 may be a general optical lens, or may also be a semi-transmissive and semi-reflective display unit.

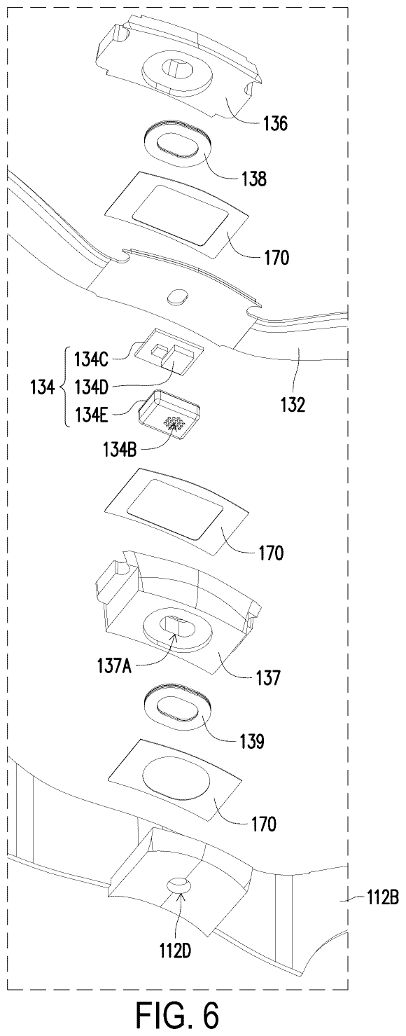

FIG. 5 is an exploded view of the smart glasses in FIG. 4. FIG. 6 is an exploded view of the smart glasses in FIG. 4 from another viewing angle. Please refer to FIG. 1, FIG. 5 and FIG. 6. In the embodiment, the directional microphone module 130 includes a flexible circuit board 132, a microphone unit 134, a first cover 136, a second cover 137, and a first waterproof air-permeable member 138. The microphone unit 134 is disposed on the flexible circuit board 132 and electrically connected to the flexible circuit board 132. The first cover 136 is disposed on the flexible circuit board 132 and located between the flexible circuit board 132 and the first opening 112A. The second cover 137 is disposed on the flexible circuit board 132. The microphone unit 134 is located between the flexible circuit board 132 and the second cover 137. The flexible circuit board 132 is located between the first cover 136 and the second cover 137. The first cover 136 has a first via 136A. The first sound receiving hole 134A of the microphone unit 134 communicates with the first opening 112A through the first via 136A. The first waterproof air-permeable member 138 is disposed on the first cover 136 and covers the first via 136A to protect the microphone unit 134 from external foreign objects and moisture, while allowing sound to pass through the first waterproof air-permeable member 138 and enter the microphone unit 134.

From the orientation in FIG. 5, the directional microphone module 130 from top to bottom sequentially includes the first cover 136, the first waterproof air-permeable member 138, the flexible circuit board 132, the microphone unit 134, and the second cover 137. The first cover 136 and the second cover 137 enclose the microphone unit 134 between the two to protect the microphone unit 134. The flexible circuit board 132 allows the microphone unit 134 to be electrically connected to the motherboard 120. That is, at least one end of the flexible circuit board 132 extends outside the body 112 to be electrically connected to the motherboard 120. When needed, the other end of the flexible circuit board 132 may also extend outside the body 112 to be electrically connected to other elements on the other side, such as the battery 160 and the speaker 150. Optionally, the cameras 140 may also be electrically connected to the motherboard 120 through the flexible circuit board 132.

In the embodiment, the directional microphone module 130 further includes, for example, a second waterproof air-permeable member 139. The second cover 137 has a second via 137A. The second sound receiving hole 134B of the microphone unit 134 communicates with the second opening 112D through the second via 137A. The second waterproof air-permeable member 139 is disposed on the second cover 137 and covers the second via 137A to protect the microphone unit 134 from external foreign objects and moisture, while sound may pass through the second waterproof air-permeable member 139 to enter the microphone unit 134. In addition, the first cover 136 and the flexible circuit board 132 may be, for example, sealed by a glue 170. The second cover 137 and the flexible circuit board 132 may be, for example, sealed by the glue 170. The second cover 137 and the first member 112B may be, for example, adhered to each other by the glue 170. The glue 170 may maintain relative locations between the directional microphone module 130 and the first member 112B during the insert molding process, and may also prevent the package material from entering an inside of the directional microphone module 130. The directional microphone module 130 and the first member 112B may also be fixed by locking, dispensing, ultrasonic welding, or other manners.

The microphone unit 134 includes, for example, a circuit board 134C, a microphone chip 134D, and an outer cover 134E. The microphone chip 134D is disposed on the circuit board 134C. The circuit board 134C has, for example, the first sound receiving hole 134A to allow the microphone chip 134D to receive sound through the first sound receiving hole 134A. The circuit board 134C and the outer cover 134E enclose the microphone chip 134D between the two to protect the microphone chip 134D. The outer cover 134E has, for example, the second sound receiving hole 134B to allow the microphone chip 134D to receive sound through the second sound receiving hole 134B.

Based on the above, in the smart glasses and the manufacturing method thereof according to the disclosure, the insert molding process is utilized to embed the directional microphone module in the frame. Therefore, the directional microphone module is closely combined with the frame to allow the overall volume and weight of the smart glasses to be reduced as much as possible, having both lightweight and convenience. Moreover, since the directional microphone module is embedded in the frame, assembly procedures may be reduced, and a good sound receiving effect may be obtained.

What is claimed is:

1. A pair of smart glasses, comprising:
a frame, comprising a body and two temples, wherein the body has a first opening;
a motherboard, disposed in one of the temples; and
a directional microphone module, embedded in the body and closely combined with the body, wherein the directional microphone module is electrically connected to the motherboard and has a first sound receiving hole, and the first sound receiving hole communicates with the first opening.

2. The smart glasses according to claim 1, wherein the body comprises a first member and a second member, the directional microphone module is fixed on the first member, the first member is closely combined with the second member, and the second member has the first opening.

3. The smart glasses according to claim 2, wherein the first member has a second opening, the directional microphone module further has a second sound receiving hole, and the second sound receiving hole communicates with the second opening.

4. The smart glasses according to claim 1, wherein the directional microphone module comprises a flexible circuit board, a microphone unit, a first cover, a second cover and a first waterproof air-permeable member, wherein the microphone unit is disposed on the flexible circuit board and electrically connected to the flexible circuit board, the first cover is disposed on the flexible circuit board and located between the flexible circuit board and the first opening, the second cover is disposed on the flexible circuit board, the microphone unit is located between the flexible circuit board and the second cover, the flexible circuit board is located between the first cover and the second cover, the first cover has a first via, the first sound receiving hole of the microphone unit communicates with the first opening through the first via, and the first waterproof air-permeable member is disposed on the first cover and covers the first via.

5. The smart glasses according to claim 4, wherein the body further has a second opening, the directional microphone module further comprises a second waterproof air-permeable member, the microphone unit further has a second sound receiving hole, the second cover has a second via, the second sound receiving hole of the microphone unit communicates with the second opening through the second via, and the second waterproof air-permeable member is disposed on the second cover and covers the second via.

6. The smart glasses according to claim 1, further comprising two cameras, disposed on both sides of the body and electrically connected to the motherboard.

7. The smart glasses according to claim 1, further comprising two speakers, respectively disposed in the temples and electrically connected to the motherboard.

8. A method of manufacturing smart glasses, comprising:
assembling a directional microphone module on a first member of a body of a frame, wherein the directional microphone module has a first sound receiving hole;
performing an insert molding process to form a second member of the body, wherein the second member is closely combined with the directional microphone module and the first member that have been assembled, the body has a first opening, and the first sound receiving hole communicates with the first opening; and
disposing a motherboard in one of two temples of the frame, wherein the directional microphone module is electrically connected to the motherboard.

9. The method of manufacturing smart glasses according to claim 8, wherein the first member is formed through an injection molding process.

10. The method of manufacturing smart glasses according to claim 8, wherein the first opening is formed in the second member.

11. The method of manufacturing smart glasses according to claim 8, wherein the microphone unit further has a second sound receiving hole, a second opening is formed in the first member, and the second sound receiving hole communicates with the second opening.
